(19) United States
(12) Patent Application Publication
(10) Pub. No.: US 2024/0085636 A1
(43) Pub. Date: Mar. 14, 2024

(54) Optical Assembly with Adapter for Intermating Different Multi-Fiber Ferrule Formats within the Adapter

(71) Applicant: US Conec Ltd., Hickory, NC (US)

(72) Inventors: Jason Higley, Hickory, NC (US); Darrell R. Childers, Hickory, NC (US); Shubhrangshu Sengupta, Hickory, NC (US)

(21) Appl. No.: 18/466,596

(22) Filed: Sep. 13, 2023

Related U.S. Application Data
(60) Provisional application No. 63/405,964, filed on Sep. 13, 2022.

(51) Int. Cl. G02B 6/38; G02B 6/40

(52) U.S. Cl. CPC G02B 6/3825; G02B 6/403

(57) ABSTRACT

An adapter receives a multi-fiber ferrule in opposing ends, the multi-fiber ferrules have different formats, end-face configurations and areas. The ferrules may be disposed in a fiber optic connector or a sleeve. In at least one embodiment, a MT ferrule is optically mated to a TMT ferrule, the MT ferrule being disposed in an MPO connector while the TMT ferrule is disposed in a VSFF connector.

### REFERENCE TO RELATED CASE

This application claims priority under 35 U.S.C. § 119 (e) to U.S. provisional application No. 63/405,964 filed on Sep. 13, 2022, the contents of which are hereby incorporated by reference in their entirety.

### BACKGROUND OF THE INVENTION

Conventional adapters for optical assemblies are designed to mate similar types of fiber-optic connectors (hereinafter, “connectors”) with similar types of fiber-optic ferrules (hereinafter “ferrules”). For example, MPO adapters connect MPO connectors on either sides thereof, each MPO connector having an MT ferrule. For example, there are adapters that connect MPO connectors to bare MT ferrules. One such adapter for mating an MPO connector directly to a bare MT ferrule is disclosed in Applicant's U.S. Pat. No. 11,237,339, the contents of which are incorporated herein by reference. Further, whenever bare ferrules are mated (single-fiber or multi-fiber), they are typically mated to identical fiber-optic ferrules. For example, a bare MT ferrule may be mated with another MT ferrule only, and not a non-MT type ferrule.

Recently, Applicant introduced the TMT ferrule, which has a significantly smaller size than the conventional MT ferrule. In addition, the TMT ferrule is shoulder-less, which in turn also enables the smaller size thereof, and one does not have to worry about shoulders cracking or breaking off (as could happen in an MT ferrule). Typically, the TMT ferrule is included within a Very Small Form Factor (“VSFF”) format connector, such as the MMC connector provided by the Applicant. Typical dimensions for the larger MT ferrule are 3.0 mm height, 8.05 mm length between the front end and the rear end, and 7 mm width. In comparison, the dimensions for the TMT ferrule are 1.25 mm height, 4 mm length (between the front end and the rear end), and a width of 6.4 mm. That is, the TMT ferrule has a much smaller footprint than the MT ferrule. The TMT ferrule and the VSFF connector are described in detail, for example, in the WIPO publication WO 2021/217050 by the Applicant. The contents of this publication are incorporated herein by reference in its entirety. Another advantage of the TMT ferrule over the MT ferrule is that the size is particularly useful in transceiver interfacing.

To enable more widespread use of the smaller TMT ferrule in the industry, there is a need to have mating infrastructure that allows mating of the TMT ferrule directly to an MT ferrule of an MPO connector to form an optical connection. Further, to expand application space and increase design flexibility, there is a need to mate dissimilar ferrule types, e.g., an MT ferrule to a non-MT multi-fiber ferrule.

### SUMMARY OF THE INVENTION

According to one aspect, the present invention is directed to an adapter for mating two dissimilar multi-fiber ferrules that includes a main body having a top wall, a bottom wall, and two opposite side walls joining the top wall and the bottom wall; and a main opening extending between a first end and a second end of the main body and along a longitudinal axis of the main body, wherein the main opening is smaller at the first end than at the second end to receive a first multi-fiber ferrule having a first end face configuration at the first end, and wherein the main opening at the second end is configured to receive a second multi-fiber ferrule having a second end face configuration that is different from the first end face configuration, the first multi-fiber ferrule and the second multi-fiber ferrule mating to form an optical connection within the main body.

In some embodiments, the first multi-fiber ferrule is in a first style of a fiber optic connector and the second multi-fiber ferrule is in a second style of a second fiber optic connector.

In some embodiments, the first end face configuration has a first area and the second end face configuration has a second area, the first area being different from the second area.

In some embodiments, there the second multi-fiber ferrule is an MT multi-fiber ferrule and the first multi-fiber ferrule is a non-MT multi-fiber ferrule within a housing.

In some embodiments, the first style of a fiber optic connector is an VSFF connector and the second style of a fiber optic connector is an MPO connector.

In yet another aspect, there is an adapter for mating two dissimilar multi-fiber ferrules that includes a main body having a plurality of walls and a first end and a second end; and a main opening at least partially defined by the plurality of walls and extending along a longitudinal axis of the main body and between the first end and the second end of the main body and wherein the main opening is smaller at the first end than at the second end to receive a first multi-fiber ferrule having a first end face configuration at the first end, and wherein the main opening at the second end is configured to receive a second multi-fiber ferrule having a second end face configuration that is different from the first end face configuration, the first multi-fiber ferrule and the second multi-fiber ferrule mating to form an optical connection within the main body.

In some embodiments, the first multi-fiber ferrule is in a first style of a fiber optic connector and the second multi-fiber ferrule is in a second style of a second fiber optic connector.

In some embodiments, the first style of a fiber optic connector is a VSFF connector and the second style of a fiber optic connector is an MPO connector.

In some embodiments, the MPO connector has an MT ferrule and the VSFF connector has a TMT ferrule.

In some embodiments, the first end face configuration has a first area and the second end face configuration has a second area, the first area being different from the second area.

In some embodiments, the first multi-fiber ferrule is a non-MT multi-fiber ferrule and the second multi-fiber ferrule is an MT multi-fiber ferrule within a housing.

In yet another aspect, there is a mated pair of multi-fiber ferrules forming an optical connection that includes a first multi-fiber ferrule having a first end-face with a first area and a first plurality of optical fibers being terminated at the first end-face; and a second multi-fiber ferrule having a second end-face with a second area and a second plurality of optical fibers being terminated at the second end-face, wherein the first area is different from the second area, and wherein in a mated configuration inside a hybrid adapter, the first multi-fiber ferrule and the second multi-fiber ferrule engage each other at the first end-face and the second end-face to form an optical connection between the first plurality of optical fibers and the second plurality of optical fibers.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a perspective view of one embodiment of a optical assembly having an adapter configured to receive and mate the VSFF connector on a first side to the MPO connector on a second side according to the present invention;

FIG. 2 is a perspective view of a TMT ferrule and an MT ferrule;

FIG. 3 is top perspective view of a cross section of the optical assembly in FIG. 1 before mating;

FIG. 4 is a top perspective view of a cross section of the optical assembly in FIG. 1 showing the ferrules mated to one another;

FIG. 5 is a side view of a cross section of the assembly in FIG. 4;

FIG. 6 is a perspective view of the adapter in the optical assembly of FIG. 1;

FIG. 7 is an elevational view of the adapter in FIG. 6 from the MPO side;

FIG. 8 is an elevational view of the adapter in FIG. 6 from the MMC side;

FIG. 9 is a perspective view of another embodiment of an optical assembly having an adapter that is used with an MPO connector on one side and a TMT ferrule and sleeve on the other;

FIG. 10 is a perspective view of the adapter in FIG. 9 with the TMT ferrule and sleeve removed from the adapter;

FIG. 11 is a perspective view from the front of the TMT ferrule and sleeve;

FIG. 12 is a perspective view from the rear of the TMT ferrule and sleeve;

FIG. 13 is a perspective view of a trigger used with the optical assembly of FIG. 9;

FIG. 14 is a side view of a cross section of the adapter and the multi-fiber ferrules in FIG. 9;

FIG. 15 is a partial view of the adapter in FIG. 9 with the multi-fiber ferrules in a mated configuration;

FIG. 16 is a perspective view of the adapter view of the adapter in FIG. 9 from the TMT side;

FIG. 17 is a perspective view of another embodiment of an optical assembly with an adapter that is used with an MPO connector on one side and a TMT ferrule with a ferrule push on the other;

FIG. 18 is a perspective view of the optical assembly of FIG. 17 with the MPO connector on one side and a TMT ferrule with a ferrule push on the other with the adapter removed for clarity;

FIG. 19 is an elevational view of a cross section of the optical assembly in FIG. 17;

FIG. 20 is a perspective view of the TMT end of the adapter in FIG. 17; and

FIG. 21 is an enlarged perspective view of a cross section of the adapter in FIG. 17.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

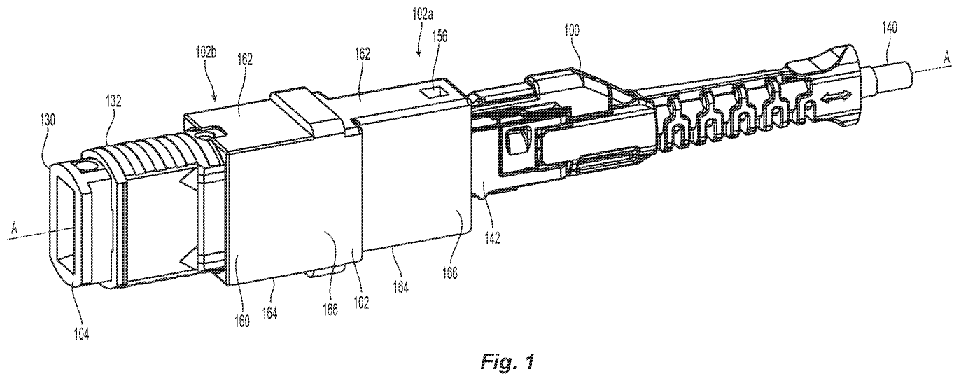

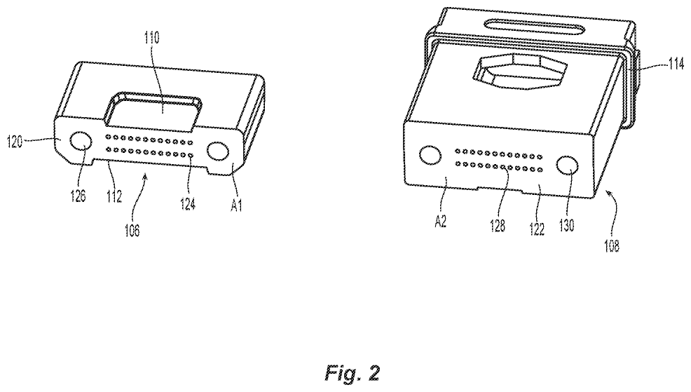

Illustrated in FIGS. 1-8 is one embodiment of a mated pair of dissimilar multi-fiber ferrules forming an optical connection. The term “dissimilar” as used herein refers to two different types of fiber-optic ferrules, and not simply two different fiber-optic ferrules of the same type. For example, two dissimilar multi-fiber ferrule may have at least one structural difference, such as, different end-face configurations. The mated pair of multi-fiber ferrules includes a first fiber optic connector 100 inserted on a first side 102a of a hybrid adapter 102 and a second fiber optic connector 104 inserted on a second side 102b of the hybrid adapter 102. In this respect, the term “hybrid” as used herein refers to an adapter or a receptacle that mates two dissimilar ferrules, or two connectors having dissimilar ferrules. Each of the fiber optic connectors 100, 104 have a differently configured multi-fiber ferrule 106, 108, respectively. See FIG. 2. The first fiber optic connector 100, which is a VSFF connector provided by the Applicant, includes a TMT multi-fiber ferrule 106. Illustrated in FIG. 2 is a TMT multi-fiber ferrule 106. As noted above, the TMT multi-fiber ferrule 106 is significantly smaller than the conventional MT multi-fiber ferrule 108, also illustrated in FIG. 2. The TMT multi-fiber ferrule 106 is shoulder-less, which in turn also enables the smaller size thereof, and one does not have to worry about shoulders breaking off (as could happen in an MT multi-fiber ferrule 108). Typically, the TMT multi-fiber ferrule 106 is included within a Very Small Form Factor (“VSFF”) format connector, i.e., the MMC connector 100 provided by the Applicant. As set forth above, the dimensions for the TMT multi-fiber ferrule 106 are 1.25 mm height, 4 mm length (between the front end and the rear end), and a width of 6.4 mm. There are also cut-outs 110, 112 on the TMT multi-fiber ferrule 106 to assist in locating and stabilizing the TMT multi-fiber ferrule 106 in the VSFF fiber optic connector 100.

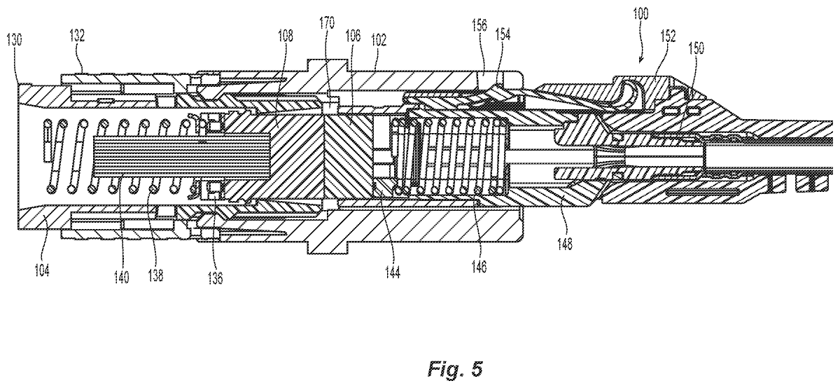

The second fiber optic connector 104 has the MT multi-fiber ferrule 108 disposed therein for mating with the TMT multi-fiber ferrule 106 in the hybrid adapter 102. See FIG. 2. As can be seen in FIG. 2, which has the multi-fiber ferrules 106, 108, in relative size to one another, the end-face 120 of the TMT multi-fiber ferrule 106 is smaller (first area A1) than the area of the end-face 122 of the MT multi-fiber ferrule 108 (second area A2). The MT multi-fiber ferrule 108 is larger in both width and height than the TMT multi-fiber ferrule 106, and the shoulder 114 makes it even larger. The end-face 120 of the TMT multi-fiber ferrule 106 also has a different configuration than that of the end-face 122 of the MT multi-fiber ferrule 108. However, the openings 124 for the optical fibers 140 (see FIG. 5) and the guide pin openings 126 in the TMT multi-fiber ferrule 106 align with the openings 128 for the optical fibers and the guide pin openings 130 in the MT multi-fiber ferrule 108. Also, there are differences in the outline/shape of the end-faces, e.g., the MT multi-fiber ferrule 108 has a rectangular configuration while the TMT multi-fiber ferrule 106 has a generally rectangular shape but with rounded corners and cut-outs 110, 112. Further, the MT multi-fiber ferrule 108 has a window forward of the shoulder 114, whereas the TMT multi-fiber ferrule 106 is window-less. Since the TMT ferrule is smaller than the MT ferrule, it would be simple to adapt the TMT ferrule into connectors that currently use MT ferrules. For example, a TMT ferrule could easily be used within an MPO connector where an MT ferrule is traditionally used. Therefore for designs shown with an MT ferrule, a TMT ferrule could also be used.

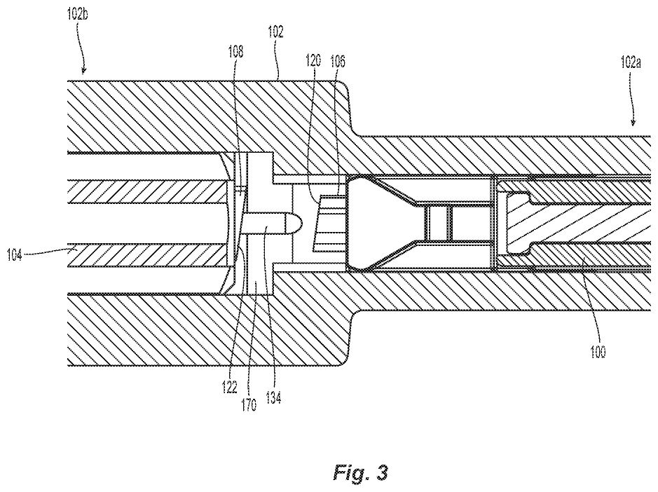

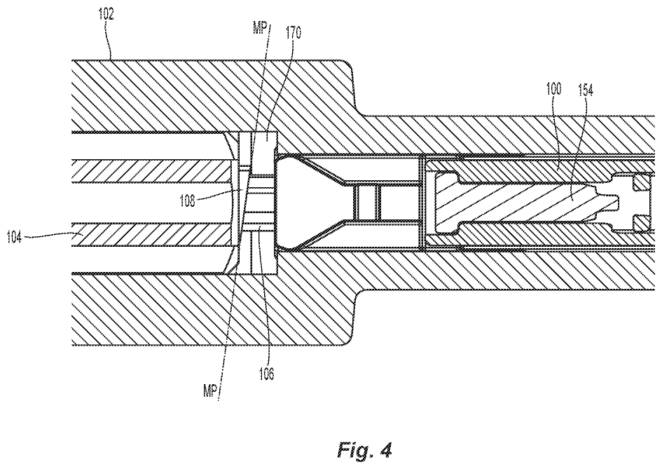

As is known from the art, the optical fibers 140 are terminated in the openings 124, 128 at the end-faces 120, 122, respectively. It should be noted that the end-faces 120, 122 may be perpendicular to a longitudinal axis A through the connectors/ferrules or they may be angle-polished. In the illustrated embodiment, the end-faces 120, 122 are angle-polished. Therefore, the mating plane MP discussed below is not perpendicular to the longitudinal axis A. See FIGS. 3 and 4.

Applicant notes that the term “front” or “forward” means that direction where the multi-fiber ferrule would meet with another multi-fiber ferrule or device, while the term “rear” or “rearward” is used to mean the direction from which the optical fibers enter into the multi-fiber ferrule or fiber optic connector. In the present application, the TMT multi-fiber ferrule 106 will therefore have a front and a rear, the front will be inserted into the hybrid adapter 102 first. Thus, in FIG. 2, the “front” of the TMT multi-fiber ferrule 106 (and also a fiber optic ferrule or connector) is pointing out of the figure and slightly to the left. The “rear” or “back” is that part of the TMT multi-fiber ferrule 106 (or fiber optic connector) that is hidden from view (and opposite to the front) and “rearward” and “backward” is slightly toward the right and into the page.

The MPO connector 104 is a standard MPO connector and has, in addition to the MT multi-fiber ferrule 108, an inner housing 130 that retains the MT multi-fiber ferrule 108, an outer housing 132 that engages the hybrid adapter 102, guide pins 134 (if the TMT multi-fiber ferrule 106 does not have guide pins), a pin keeper 136, a spring 138 and optical fibers 140. Similarly, the VSFF fiber optic connector 100 has a receiver 142 for retaining the TMT multi-fiber ferrule 106, a pin keeper or spacer 144, a spring 146, a housing 148, a crimp ring 150 and a push-pull boot 152. Naturally, there may be other components that are provided or removed from the VSFF fiber optic connector 100, depending on the use and the environment. The push-pull boot 152 has a latch 154 that engages a corresponding structure 156 on the hybrid adapter 102. In FIGS. 1, 5, and 6, the structure 156 is an opening in a top portion of the adapter 102. The structure 156 could also be a depression (that does not go all the way through the hybrid adapter 102).

Turning to FIG. 3, the two fiber optic connectors 100, 104 have been inserted into a main opening 170 of the hybrid adapter 102 from their respective sides. The two fiber optic connectors 100, 104 are approaching each other, and the guide pins 134 are about to engage the TMT multi-fiber ferrule 106. In FIGS. 4 and 5, the TMT multi-fiber ferrule 106 and the MT multi-fiber ferrule 108 have been mated by the end-faces 120, 122 touching one another to form an optical connection between the optical fibers 140 in each of the two fiber optic connectors 100, 104 at a mating plane MP.

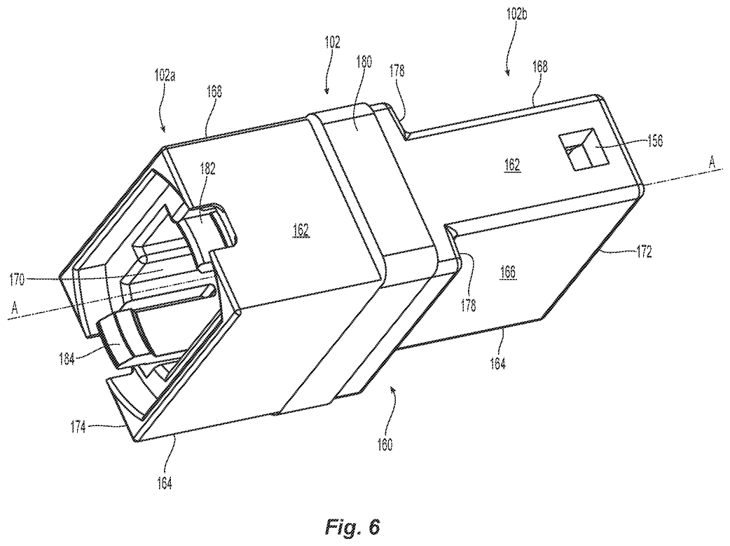

Referring to FIGS. 6-8, there is the hybrid adapter 102 that is used to mate the two dissimilar multi-fiber ferrules. i.e., the TMT multi-fiber ferrule 106 and the MT multi-fiber ferrule 108. The hybrid adapter 102 has a main body 160 with a top wall 162, a bottom wall 164, and two opposite side walls 166, 168. The two opposite side walls 166, 168 joining the top wall 162 and the bottom wall 164 to form a main opening 170 extending between a first end 172 and a second end 174 of the main body and along a longitudinal axis A (See FIG. 1) of the main body 160. The terms “top,” “bottom” and “side” are used only as a convention and for ease of discussion and are not used in a limiting or specific manner. It should be noted that the first end 172 would receive the VSFF fiber optic connector 100 and the second end 174 would receive the MPO connector 104. It does not matter which end is labeled the first end which end is labeled the second end, as long as the fiber optic connectors 100, 104 are inserted in the correct end. It should be noted that the main opening 170 is smaller at the first end 172 to receive the smaller VSFF fiber optic connector 100 with the TMT multi-fiber ferrule 106, and the main opening 170 at the second end 174 is larger to receive the larger MPO connector 104 with the larger MT multi-fiber ferrule 108.

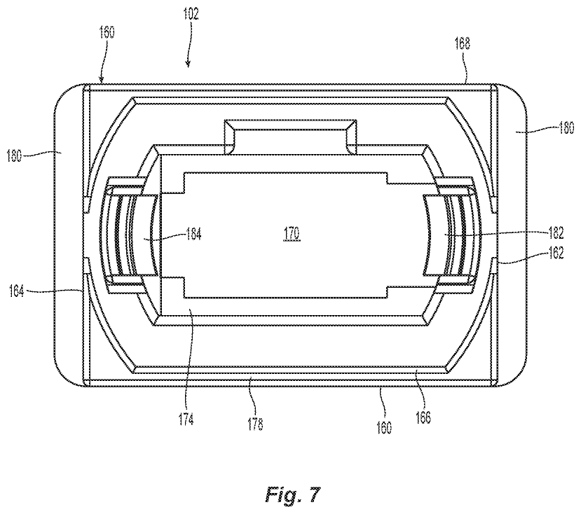

As noted above, the hybrid adapter 102 has different sizes of the main opening 170 at the different ends 172, 174. That may also true of the top wall 162, the bottom wall 164, and two opposite side walls 166, 168. For example, the top wall 162 and the bottom wall 164 may be flat between the first end 172 and the second end 174 (except for a flange discussed below), or there may be a step between the first end 172 and the second end 174 for the smaller first end 172. The same is true for the two opposite side walls 166, 168. Preferably, there is a step 178 between the first end 172 and the second end 174. See FIG. 6. This is possible due in part to the thinner VSFF fiber optic connector 100. The hybrid adapter 102 preferably has a flange 180 on the top wall 162 and the bottom wall 164 to prevent the hybrid adapter 102 from being pushed too far into a receiver/receptacle, such as an adapter panel. As can be seen in FIGS. 4 and 7, the outside surfaces of the top wall 162, the bottom wall 164, and two opposite side walls 166, 168 lie in a number of planes. In this embodiment, there are at least 6 planes, but if there were no step downs, then there would only be 4 planes—each of the top wall 162, the bottom wall 164, and the opposite side walls 166, 168 are each flat and continuous from one end to the other.

Within the main opening 170 on the second end 174 are two latch arms 182, 184 that engage the inner housing 130 of the MPO connector 104, as is standard in the industry for a connection of the MPO connector 104 in a standard MPO adapter. An example advantage of the hybrid adapter 102 is that legacy MPO connectors, such as the MPO connector 104 can mate to newer connector formats with newer type of ferrules, i.e., the VSFF fiber optic connector 100 with the TMT multi-fiber ferrule 106.

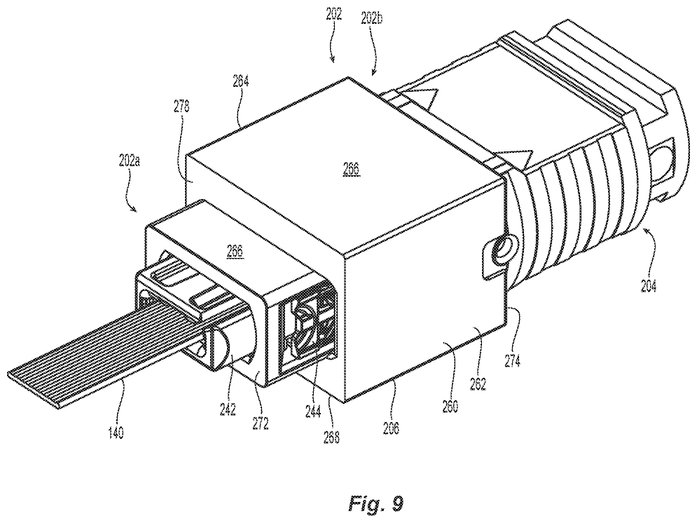

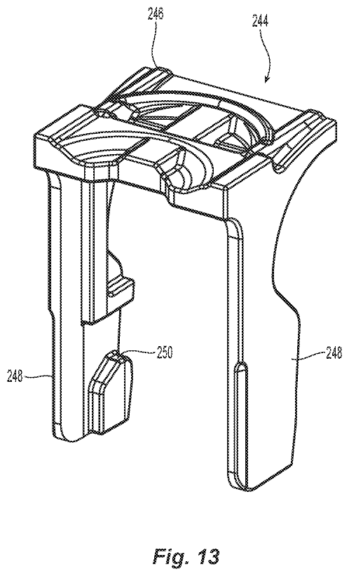

In FIGS. 9-16 is another embodiment of a mated pair of dissimilar multi-fiber ferrules forming an optical connection. The mated pair of multi-fiber ferrules illustrated therein includes a first multi-fiber ferrule 106′ inserted on a first side 202a of a hybrid adapter 202 and a second fiber optic connector 204 inserted on a second side 202b of the main opening 270 of hybrid adapter 202. In this case, the second fiber optic connector 204 is the same as the MPO connector 104 with the MT multi-fiber ferrule 108 and will not be described again here. The first multi-fiber ferrule 106′ is similar to the TMT ferrule 106 described above, except that this embodiment of the multi-fiber TMT ferrule 106 only has one row of optical fibers 140. Similarly, the MT multi-fiber ferrule 108 would typically also have one row of optical fibers. This embodiment of a hybrid adapter may also use the TMT multi-fiber ferrule 106 and the MT multi-fiber ferrule 108. Further, in this embodiment, rather than the TMT multi-fiber ferrule 106′ being disposed within a multi-component connector, the TMT multi-fiber ferrule 106′ is retained with the hybrid adapter 202 by a sleeve 242.

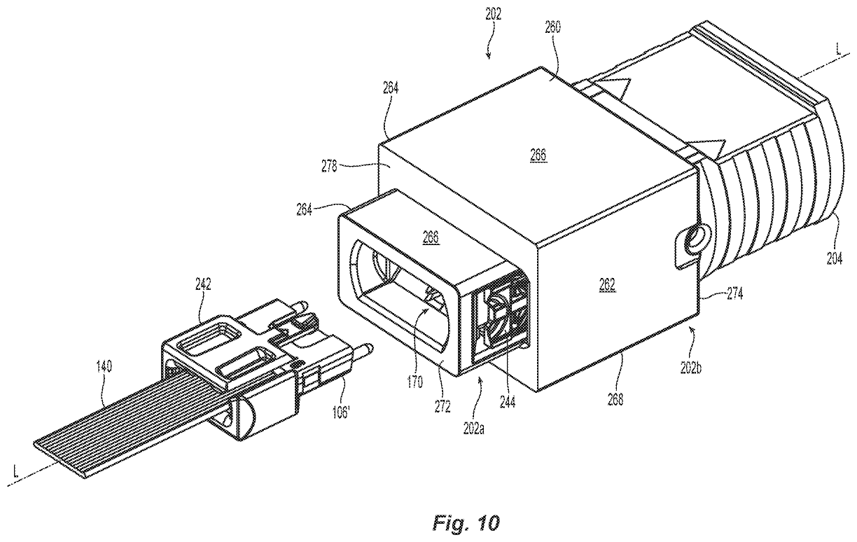

The hybrid adapter 202 is the same on the second side 202b as in the first embodiment. That is, the hybrid adapter 202 has a main body 260 with a top wall 262, a bottom wall 264, and two opposite side walls 266, 268. The two opposite side walls 266, 268 joining the top wall 262 and the bottom wall 264 to form a main opening 270 extending between a first end 272 and a second end 274 of the main body and along a longitudinal axis L (See FIG. 10) of the main body 260. The hybrid adapter 202 has different sizes of the main opening 270 at the different ends 272, 274. The top wall 262, the bottom wall 264, and two opposite side walls 266, 268 may also have different sizes. For example, due to the different sizes in the MPO connector 104 and the multi-fiber ferrule 106′, the adapter 202 may be smaller at one of the ends. In this case, the top wall 262, the bottom wall 264, and two opposite side walls 266, 268 may not be flat from the first side 202a to the second side 202b due to the size difference. See FIGS. 9 and 10. In this case, there is a step down 278 between the sides for the top wall 262 and the bottom wall 264 and two opposite side walls 266, 268. See FIG. 9. Alternatively, the outside of the hybrid adapter 202 may be flat between the first end 272 and the second end 274. The hybrid adapter 202 may have a flange on the top wall 262 and the bottom wall 264 to prevent the hybrid adapter 202 from being pushed too far into a receiver/receptacle, such as an adapter panel. The flange is not shown in the embodiment, but it would be similar to the flange 180 in the first embodiment. As can be seen in FIGS. 9, 10, and 16, the outside surfaces of the top wall 262, the bottom wall 264, and two opposite side walls 266, 268 lie in a number of planes. In this embodiment, there are at least 8 planes, but if there were no step downs, then there would only be 4 planes—each of the top wall 262, the bottom wall 264, and the opposite side walls 266, 268 would each be flat and continuous from one end to the other.

In this embodiment, the first side 202a of the hybrid adapter 202 is different in that it is configured to receive the TMT multi-fiber ferrule 106′ and the sleeve 242. See FIGS. 9 and 10. There is also a trigger 244 that is used to release the TMT multi-fiber ferrule 106′ and the sleeve 242 from the hybrid adapter 202 when needed. See FIGS. 9, 10, 13, and 14. The trigger is discussed below with regard to the hybrid adapter 202.

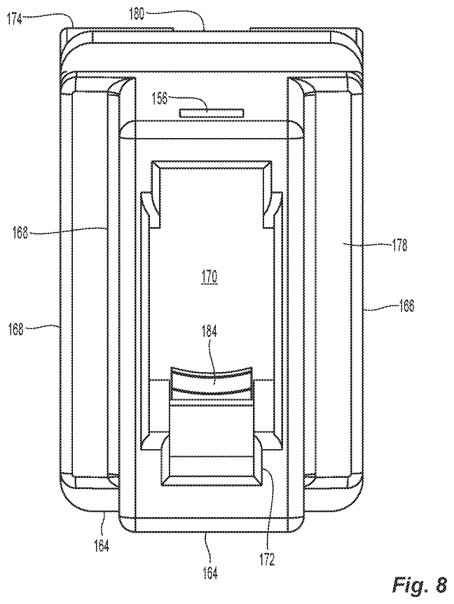

Turning now to FIGS. 10-12, there is the sleeve 242 that is used with the TMT multi-fiber ferrule 106′ and the adapter 202. Generally, the sleeve 242 makes it easier to handle the bare TMT multi-fiber ferrule 106′, especially during insertion into and removal of the TMT multi-fiber ferrule 106′ from the adapter 202. The sleeve 242 has a body 300 with a first side 302, a second side 304 opposite the first side 302, a top side 306, and a bottom side 308 opposite the top side 306. The top side 306 and the bottom side 308 are preferably curved, with the curvature extending the farthest away from the body 300 approximately half way between the first side 302 and the second side 304. See FIGS. 8 and 9. The body 300 also has a central opening 310 defined at least in part by the first side 302, the second side 304, the top side 306, and the bottom side 308. The central opening 310 receives the optical fibers 140 that are secured within the TMT multi-fiber ferrule 106. The optical fibers 140 may be in a ribbon format or loose optical fibers terminated at openings 124′ at an end face 124′.

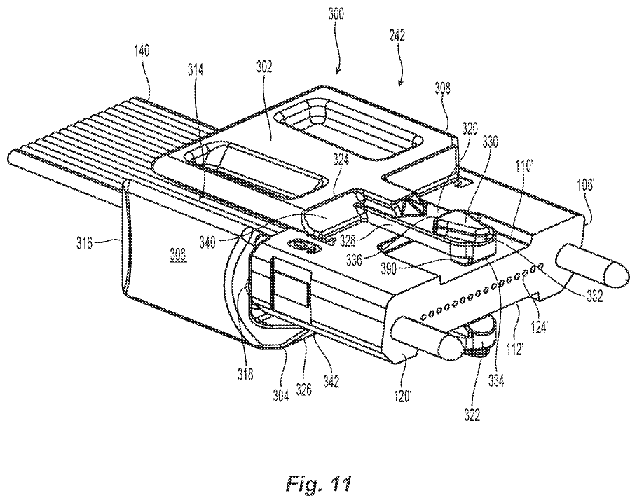

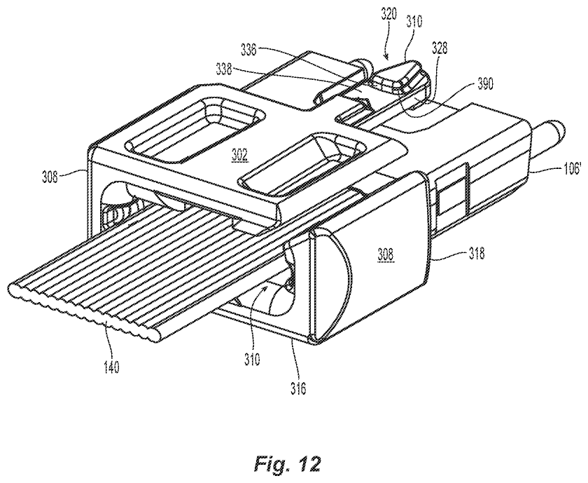

The sleeve 242 has a slot 314 extending longitudinally from a back end 316 of the fiber optic ferrule holder 306 to a front end 318 of the central opening 310. See FIGS. 11 and 12. As seen, the location of the slot 314 is about where the first side 302 meets with the top side 306. However, the slot 314 could be located in other places around and on the body 300 and still fall within the scope of the present invention. Preferably, the slot 314 is dimensioned so that it is larger than the optical fibers or optical ribbons to fit through the slot. For example, for the use of a 2 row ferrule, the slot would be wider than the height of 2 ribbons.

Extending longitudinally from the first side 302 and the second side 304 are sleeve extensions 320, 322. The first sleeve extension 320 extends from the front 324 of the first side 302 and the second sleeve extension 322 extends from the front 326 of the second side 304. Each of the first sleeve extension 320 and the second sleeve extension 322 is a mirror image of each other and therefore only the first sleeve extension 320 will be discussed. The discussion will also apply to the second sleeve extension 322.

The first sleeve extension 320 has a main arm 328 with a head portion 330, the head portion 330 having opposing chamfered side surfaces 332 that generally face forward. These chamfered side surfaces 332 assist in aligning the sleeve 242 and the TMT multi-fiber ferrule 106′ with the hybrid adapter 202. The sleeve extensions 320, 322 also each have a chamfered surface 334 that face each other and assist in spreading the sleeve extensions 320, 322 away from each other when the sleeve 242 is installed on the TMT multi-fiber ferrule 106′. Moving from the head portion 330 backwards toward the first side 302, there is a ramp stop surface 336 on the back of the head portion 330 that faces toward the first side 302 and engages the adapter 202. Also between the ramp stop surface 336 and the first side 302 is a groove 338 that receives a portion of the adapter 202.

There is another chamfered surface that further assists the sleeve 242 with the TMT multi-fiber ferrule 106 to be installed in the adapter 202. That is, the first side 302 and the second side 304 have a chamfered surface 340, 342, respectively, that extend from the front thereof. The chamfered surface 340 extends from the front 324 of the first side 302, while the chamfered surface 342 extends from the front 326 of the second side 304. The chamfered surfaces 340, 342 assist in aligning the sleeve 242 and the TMT multi-fiber ferrule 106 with the adapter 202.

Finally, with respect to the sleeve 242 there is a rear facing stop surface 390 on each of the sleeve extensions 320, 322. Each of the rear facing stop surfaces 390 are configured to engage the forward facing surfaces (ferrule stop surfaces) of the cut-outs 110′, 112′ of the TMT multi-fiber ferrule 106′, respectively. Thus, when one pulls on the sleeve 242, the sleeve extensions 320, 342 move relative to the TMT multi-fiber ferrule 106′ and the rear facing stop surfaces 390 engage the forward facing surfaces of the cut-outs 110′, 112′ of the TMT multi-fiber ferrule 106′ pulling the fiber optic ferrule 106′ out of the adapter 202 with the sleeve 242. The holder extensions 320, 322 are generally made of plastic material and are biased to be in contact with the of the cut-outs 110, 112 of the TMT multi-fiber ferrule 106′.

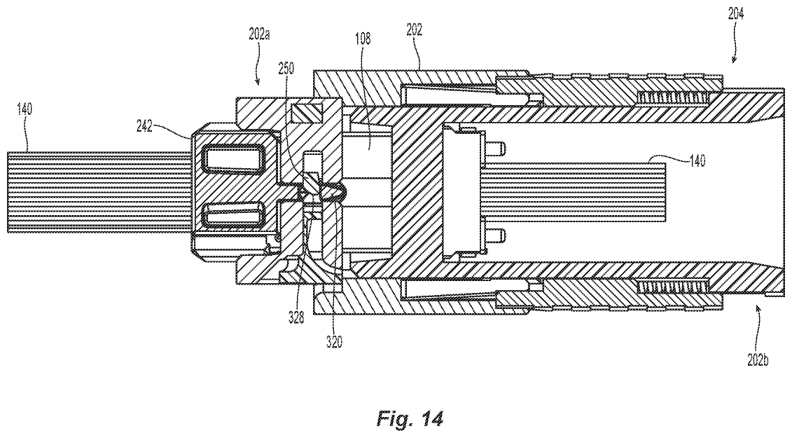

Also in the hybrid adapter 202 is the trigger 244 that is on the top surface of the hybrid adapter 202 and preferably at the junction of the first side 202a and the second side 202b. See FIGS. 9 and 10. The trigger 244 has a top portion 246 and legs 248 that extend into the main opening 270 of the hybrid adapter 202. As the TMT multi-fiber ferrule 106′ and the sleeve 242 are inserted into the hybrid adapter 202, the head portion 330 of the sleeve 242 engages the legs 248 and an upward extending protrusion 250, in particular. The head portion 330 pushes the protrusion 250 downward and the TMT multi-fiber ferrule 106′ and the sleeve 242 are advanced and are then captured by the protrusion 250 disposed within the groove 338. See FIG. 14. When the TMT multi-fiber ferrule 106′ and the sleeve 242 are to be removed, one pushes down on the top portion 246 of the trigger 244 and the protrusion 250 moves downward and out of the groove 338 and the head portion 330 (along with TMT multi-fiber ferrule 106′ and the sleeve 242) can be pulled out of the adapter 202.

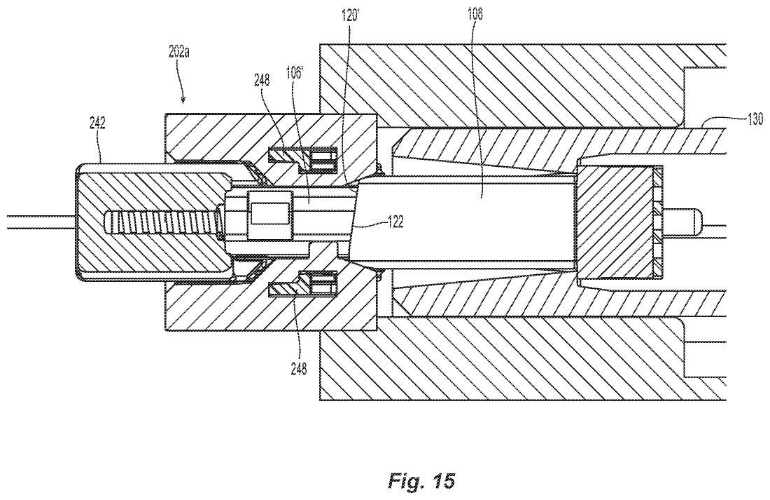

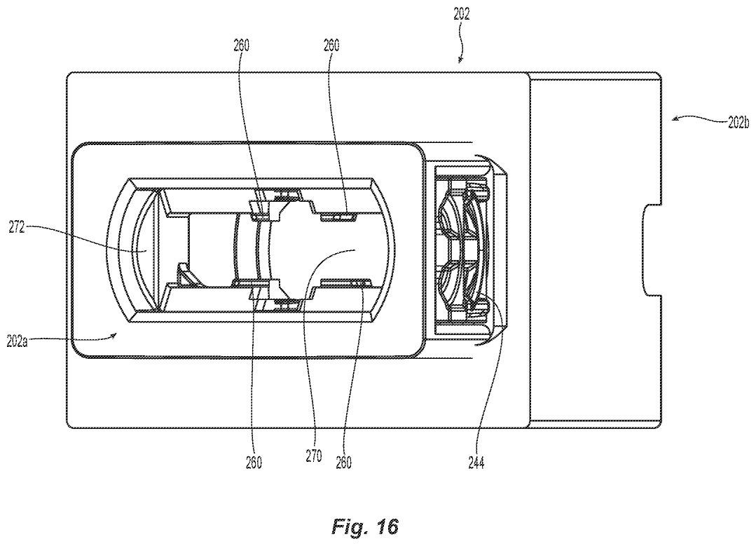

There are also pedestals 260 within the main opening 270. See FIG. 16. The pedestals 260 are designed and placed to engage the cut-outs 110′, 112′ of the TMT multi-fiber ferrule 106′. The pedestals 260 help to center the TMT multi-fiber ferrule 106′ and also to provide a stop within the cut-outs 110′, 112′ so that the TMT multi-fiber ferrule 106′ is not inserted too deeply into the main opening 270. There may also be a sleeve stop 272 that are on the top and bottom of the main opening 270 to provide another safeguard and prevent the sleeve 242 from going in too far. The TMT multi-fiber ferrule 106′ mates with the MT multi-fiber ferrule 108 inside the hybrid adapter 202, as shown, for example, in FIG. 15.

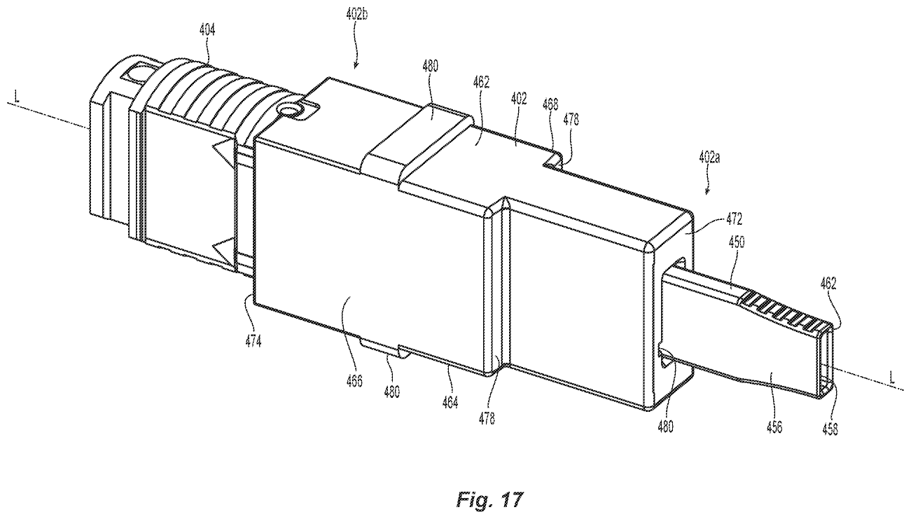

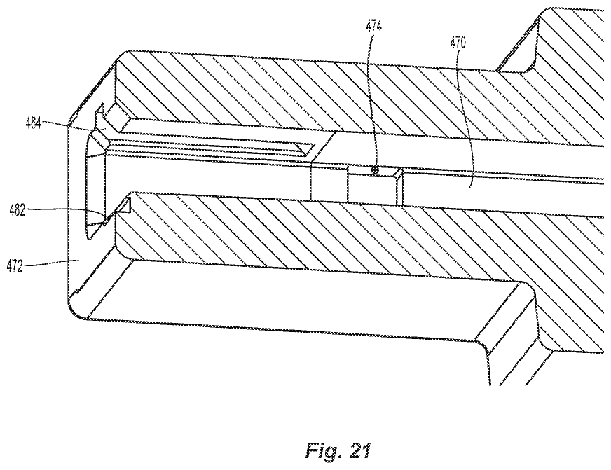

Another embodiment of a mated pair of dissimilar multi-fiber ferrules forming an optical connection is illustrated in FIGS. 17-21. The mated pair of multi-fiber ferrules includes a first multi-fiber ferrule 106 inserted into a main opening 470 of a first side 402a of a hybrid adapter 402 and a second fiber optic connector 404 inserted into the main opening 470 on a second side 402b of hybrid adapter 402. In this case, the second fiber optic connector 404 is the same as the MPO connector 104 with the MT multi-fiber ferrule 108 as used in both of the second fiber optic connectors discussed above. The first multi-fiber ferrule 106 is the TMT ferrule also described above; however, rather than the TMT multi-fiber ferrule 106 being disposed within a multi-component connector or a sleeve, there is a ferrule push 404 that is disposed around the optical fibers 140 and behind the TMT multi-fiber ferrule 106 and retains the TMT multi-fiber ferrule 106 within the hybrid adapter 402. It should be noted that since the multi-fiber ferrules are the same multi-fiber ferrules discussed above, they have the same shape and size of those previously discussed ferrules. Thus, the area and configuration of the end-face 120 of the TMT multi-fiber ferrule 106 is smaller than the area of the end-face 122 of the MT multi-fiber ferrule 108 in this embodiment.

The hybrid adapter 402 is the same on the second side 402b as in the first two embodiments. However, the first side 402a of the hybrid adapter 402 is different in that it is configured to receive the TMT multi-fiber ferrule 106 and the ferrule push 404. See FIGS. 17-19. The first side 402a of the hybrid adapter 402 with the TMT multi-fiber ferrule 106 and the ferrule push 404 also has an outer circumference that is smaller than the circumference on the second side 402b, due in part to the smaller size of the TMT multi-fiber ferrule 106 and the ferrule push 404. The configuration of the outside of the hybrid adapter 402 is similar to that of the hybrid adapter 102. That is, the top wall 462 and the bottom wall 464 are flat between the first end 472 and the second end 474 (except for a flange), and for the opposite side walls 446 there is preferably a step 478 between the first end 472 and the second end 474. See FIG. 17. This is possible due in part to the thinner TMT multi-fiber ferrule 106 and the ferrule push 404. The hybrid adapter 402 preferably has a flange 480 on the top wall 462 and the bottom wall 464 to prevent the hybrid adapter 402 from being pushed too far into a receiver/receptacle, such as an adapter panel.

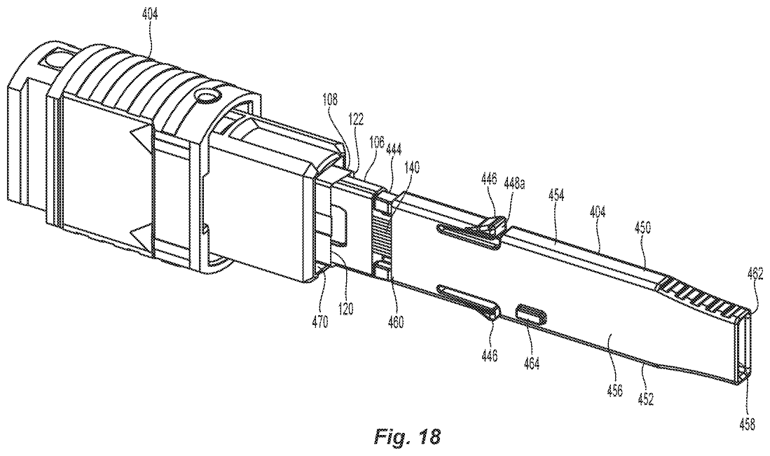

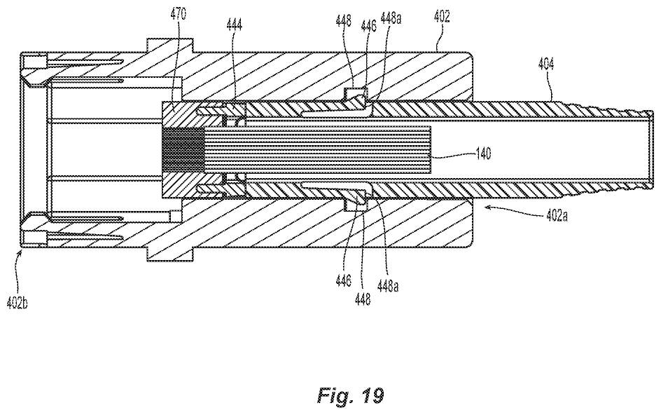

As seen in FIGS. 18 and 19, there is a spacer 444 that is preferably positioned between the TMT multi-fiber ferrule 106 and the ferrule push 404. The spacer 444 assists in distributing the force of the ferrule push 404 on the TMT multi-fiber ferrule 106, but the ferrule push 404 could be configured to engage the TMT multi-fiber ferrule 106 directly. The ferrule push 404 has a top wall 450, a bottom wall 452, and two side walls 454, 456 that are positioned between the top wall 450, a bottom wall 452 to define a central opening 458 between the front end 460 and the rear end 462 that receives the optical fibers 140.

The ferrule push 404 has several features that are relevant to its use with the TMT multi-fiber ferrule 106. First, there is a polarity key or feature 464 on one of the walls, the side wall 456 is illustrated as having it in FIG. 18. The polarity key or feature 464 could be on any of the other walls as well.

There are also two latches 446 on opposite sides of the ferrule push 404. In this case, two latches 446 are on the top and bottom walls 450, 452. As can be seen in FIGS. 18 and 19, the two latches 446 are cantilevered projections that extend slightly beyond the edges of the ferrule push 404. The two latches 446 have rearward facing flat surfaces 448a that engage pockets or depressions 448 within the hybrid adapter 402 to prevent the ferrule push 404 from coming out of the main opening 470. This arrangement keeps the TMT multi-fiber ferrule 106 in a position for mating with the MPO connector 104 with the MT multi-fiber ferrule 108.

The first side 402a of the hybrid adapter 402 preferably includes a polarity groove 484 that receives the polarity key or feature 464. See FIGS. 17, 20, and 21. This feature ensures that the MPO connector 104 with the MT multi-fiber ferrule 108 aligns with the TMT multi-fiber ferrule 106 and the ferrule push 404 so that optical fibers 140 in each of the connectors are optically aligned upon mating of the first multi-fiber ferrule 106 with the second multi-fiber ferrule inside the adapter 402.

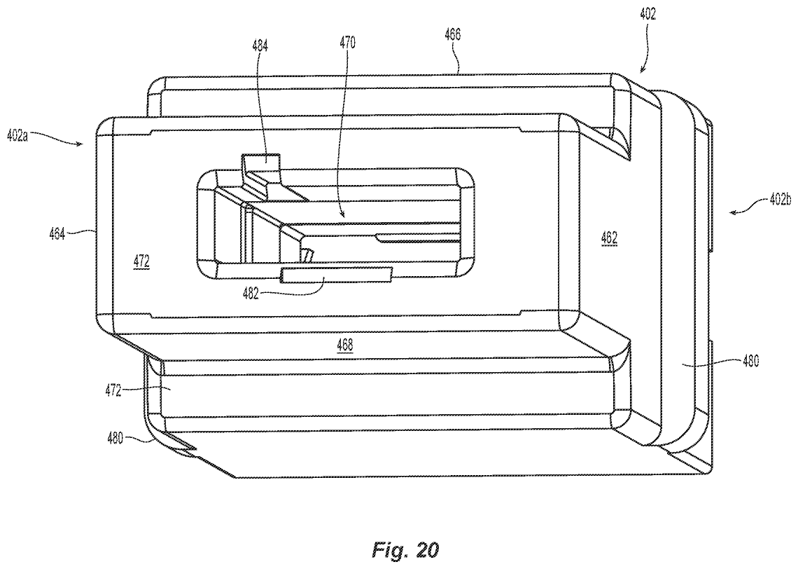

There is another analogous feature that may be provided on the ferrule push 404—a polarity check feature 482. In FIG. 20, this shows as a flat, rearward facing surface 482. The polarity check feature 482 provides a stop surface for the polarity key or feature 464. If the TMT multi-fiber ferrule 106 and the ferrule push 404 are inverted relative to the correct positioning, the polarity key or feature 464 will hit the polarity check feature 482, preventing the TMT multi-fiber ferrule 106 and the ferrule push 404 from being inserted incorrectly. The user will then know to flip the TMT multi-fiber ferrule 106 and the ferrule push 404 180 degrees for the correct alignment. Obviously, the two features, the polarity key or feature 464 and the polarity check feature 482 will have to be on opposite sides of the ferrule push 404 to perform their functions. Both the polarity key or feature 464 and the polarity check feature 482 can take other forms and still fall within the scope of the present invention.

An optical assembly for mating a pair of fiber optic connectors that includes a hybrid adapter having a longitudinal main opening between a first end and a second end, the main opening being smaller at one of the first end and the second end than at the other of the first end and the second end, and the hybrid adapter having a main body, a first fiber optic connector having a fiber-optic ferrule of a first end face configuration, the first fiber optic connector received at the first end and positioned for mating inside the main body of the hybrid adapter, and a second fiber optic connector having a fiber-optic ferrule of a second end face configuration, the second fiber optic connector received at the second end and also positioned for mating inside the main body hybrid adapter with the first fiber optic connector.

The optical assembly discussed above wherein the first fiber optic connector is an MPO connector and the second fiber optic connector is a very small form factor (VSFF) connector.

We claim:

1. An adapter for mating two dissimilar multi-fiber ferrules, comprising:
a main body having a top wall, a bottom wall, and two opposite side walls joining the top wall and the bottom wall; and
a main opening extending between a first end and a second end of the main body and along a longitudinal axis of the main body,
wherein the main opening is smaller at the first end than at the second end to receive a first multi-fiber ferrule having a first end face configuration at the first end, and
wherein the main opening at the second end is configured to receive a second multi-fiber ferrule having a second end face configuration that is different from the first end face configuration, the first multi-fiber ferrule and the second multi-fiber ferrule mating to form an optical connection within the main body.

2. The adapter according to claim 1, wherein the first multi-fiber ferrule is in a first style of a fiber optic connector and the second multi-fiber ferrule is in a second style of a second fiber optic connector.

3. The adapter according to claim 2, wherein the first style of a fiber optic connector is a VSFF connector and the second style of a fiber optic connector is an MPO connector.

4. The adapter according to claim 3, wherein the MPO connector has an MT ferrule and the VSFF connector has a TMT ferrule.

5. The adapter according to claim 1, wherein the first end face configuration has a first area and the second end face configuration has a second area, the first area being different from the second area.

6. The adapter according to claim 1, wherein the second multi-fiber ferrule is an MT multi-fiber ferrule and the first multi-fiber ferrule is a non-MT multi-fiber ferrule within a housing.

7. The adapter according to claim 1, wherein the first multi-fiber ferrule terminates a first plurality of optical fibers at a first end face thereof and the second multi-fiber ferrule terminates a second plurality of optical fibers at a second end face thereof, the first plurality of optical fibers being optically aligned to the second plurality of optical fibers upon mating of the first multi-fiber ferrule with the second multi-fiber ferrule inside the main body of the adapter.

8. An adapter for mating two dissimilar multi-fiber ferrules, comprising:
a main body having a plurality of walls and a first end and a second end; and
a main opening at least partially defined by the plurality of walls and extending along a longitudinal axis of the main body and between the first end and the second end of the main body and,
wherein the main opening is smaller at the first end than at the second end to receive a first multi-fiber ferrule having a first end face configuration at the first end, and
wherein the main opening at the second end is configured to receive a second multi-fiber ferrule having a second end face configuration that is different from the first end face configuration, the first multi-fiber ferrule and the second multi-fiber ferrule mating to form an optical connection within the main body.

9. The adapter according to claim 8, wherein the first multi-fiber ferrule is in a first style of a fiber optic connector and the second multi-fiber ferrule is in a second style of a second fiber optic connector.

10. The adapter according to claim 9, wherein the first style of a fiber optic connector is a VSFF connector and the second style of a fiber optic connector is an MPO connector.

11. The adapter according to claim 10, wherein the MPO connector has an MT ferrule and the VSFF connector has a TMT ferrule.

12. The adapter according to claim 8, wherein the first end face configuration has a first area and the second end face configuration has a second area, the first area being different from the second area.

13. The adapter according to claim 8, wherein the first multi-fiber ferrule is a non-MT multi-fiber ferrule and the second multi-fiber ferrule is an MT multi-fiber ferrule within a housing.

14. The adapter according to claim 8, wherein the first multi-fiber ferrule terminates a first plurality of optical fibers at a first end face thereof and the second multi-fiber ferrule terminates a second plurality of optical fibers at a second end face thereof, the first plurality of optical fibers being optically aligned to the second plurality of optical fibers upon mating of the first multi-fiber ferrule with the second multi-fiber ferrule inside the main body of the adapter.

15. A mated pair of multi-fiber ferrules forming an optical connection, comprising:
a first multi-fiber ferrule having a first end-face with a first area and a first plurality of optical fibers being terminated at the first end-face; and
a second multi-fiber ferrule having a second end-face with a second area and a second plurality of optical fibers being terminated at the second end-face,
wherein the first area is different from the second area, and
wherein in a mated configuration inside a hybrid adapter, the first multi-fiber ferrule and the second multi-fiber ferrule engage each other at the first end-face and the second end-face to form an optical connection between the first plurality of optical fibers and the second plurality of optical fibers.

16. The mated pair of multi-fiber ferrules according to claim 15, wherein the first multi-fiber ferrule is a TMT ferrule and the second multi-fiber ferrule is an MT ferrule within a housing.
